(19) United States
(12) Patent Application Publication
(10) Pub. No.: US 2021/0105417 A1
(43) Pub. Date: Apr. 8, 2021

(54) WEARABLE CAMERA DEVICE

(71) Applicant: LINKFLOW CO., LTD, Seoul (KR)

(72) Inventors: Yong Kuk KIM, Gyeonggi-do (KR); Sung Rae CHO, Seoul (KR); Yong Jin KIM, Seoul (KR); Jun Se KIM, Gyeonggi-do (KR)

(21) Appl. No.: 16/770,541

(22) PCT Filed: Dec. 15, 2017
(86) PCT No.: PCT/KR2017/014789

§ 371 Date: Dec. 11, 2020

(30) Foreign Application Priority Data
Dec. 11, 2017 (KR) 10-2017-0169690

(51) Int. Cl. H04N 5/247; H04N 5/232; H04N 5/225; H04N 1/00

(52) U.S. Cl. CPC H04N 5/247; H04N 5/23241; H04N 1/00209; H04N 1/00244; H04N 5/2253

(57) ABSTRACT

The present invention relates to a wearable camera device and is characterized by including: an elastic frame (110) which is detachably coupled to the neck of a user and in which a plurality of camera holders (114, 115, 116, 117) are provided spaced apart from each other; a plurality of camera modules (120, 120a, 120b, 120c) which are coupled to the plurality of camera holders (114, 115, 116, 117) and generate image data of different viewing angles around the user; a battery (130) provided spaced apart from the elastic frame (110); and a battery connection tube (140) which connects the battery (130) and the elastic frame (110), and guides a plurality of camera power supply lines (142, 143, 144, 145), which respectively supply power to the plurality of camera modules (120, 120a, 120b, 120c), to the elastic frame (110).

### TECHNICAL FIELD

The present invention relates to a wearable camera, and more specifically, to a wearable camera which is comfortably worn around the neck of a user and stably captures images at various angles simultaneously.

### BACKGROUND ART

Wearable cameras are cameras which are wearable on the heads or ears of users, capture images of surrounding environments, and simultaneously allow the users to freely use their hands.

An example of such a wearable camera is disclosed in Korean Patent Publication No. 10-2005-0089371 “HEADSET MOVING CAMERA FOR ONE PERSON DOCUMENTARIAN”. In the disclosed conventional wearable camera, a camera module is installed on a body formed in the form of an ear-set or goggle, and when the conventional wearable camera is worn on ears, two hands can be freely used and an image of a surrounding environment can be captured.

However, the disclosed conventional wearable camera has a restrictive condition of being worn on only the ears and a problem of hiding some fields of view.

In addition, since a frame of the conventional wearable camera is formed of rigid plastic or a metal material, when the conventional wearable camera is worn for a long time, it may cause fatigue, a foreign body sensation, and discomfort.

Meanwhile, wearable cameras are used for documentary writers to capture images of target environments or for police officers dispatched to emergency sites to capture images of site situations. However, since only one camera is installed on the disclosed conventional wearable camera, an image can only be captured in a specific direction, and thus there is a restriction in which images at various angles are not captured.

In addition, due to limitations of a power supply line to be buried and activity of the conventional wearable camera, the conventional wearable camera is formed such that a battery is integrally embedded in the camera. Accordingly, activity can be secured, but a charging amount of the battery is small, and thus, there is a limitation of short image capturing time.

### Technical Problem

The present invention is directed to providing a wearable camera device capable of supporting a plurality of cameras to simultaneously obtain images at various angles.

The present invention is also directed to providing a wearable camera device capable of being worn around the neck of a user to obtain a stable image without hiding a field of view of a user.

The present invention is also directed to providing a wearable camera device capable of being worn for a long time due to an excellent wearing sensation and securing a long image capturing time.

The objectives and various advantages of the present invention will be clear to those who are skilled in the art through exemplary embodiments of the present invention.

### Technical Solution

According to an aspect of the present invention, there is provided a wearable camera device including an elastic frame (110) which is detachably coupled to a neck of a user and in which a plurality of camera holders (114, 115, 116, 117) are provided to be spaced apart from each other, a plurality of camera modules (120, 120a, 120b, 120c) coupled to the plurality of camera holders (114, 115, 116, 117) to generate pieces of image data at different viewing angles around the user, a battery (130) provided to be spaced apart from the elastic frame (110), and a battery connection tube (140) which connects the battery (130) and the elastic frame (110) and guides a plurality of camera power supply lines (142, 143, 144, 145), through which power is supplied to the plurality of camera modules (120, 120a, 120b, 120c), to the elastic frame (110).

The elastic frame (110) may include a back-neck frame (111) which is disposed behind the neck of the user, has a lower portion in which a connection tube coupling hole (111a) coupled to the battery connection tube (140) is formed, accommodates the plurality of camera power supply lines (142, 143, 144, 145) therein, and is formed of an elastic material, a left frame (112) and a right frame (113) which are formed to extend from both sides of the back-neck frame (111) toward a front of the neck of the user, a first camera holder (114) which is provided between the back-neck frame (111) and the left frame (112) and accommodates a first camera module (120), a second camera holder (115) which is provided between the back-neck frame (111) and the right frame (113) and accommodates a second camera module (120a), a third camera holder (116) which is provided on an end portion of the left frame (112) and accommodates a third camera module (120b), and a fourth camera holder (117) which is provided on an end portion of the right frame (113) and accommodates a fourth camera module (120c).

The wearable camera device may further include a charging cradle (150) which is electrically connected to the battery (130) and charges the battery (130).

The plurality of camera modules (120, 120a, 120b, 120c) may transmit the generated image data to a manager server through wireless communication.

The plurality of camera modules (120, 120a, 120b, 120c) may include storages (123, 123a, 123b, 123c) which each store one of the pieces of generated image data.

The wearable camera device may further include a body fixing band (160) provided on the end portion of each of the left frame (112) and the right frame (113) to fix the elastic frame (110) to the neck of the user.

### Advantageous Effects

In the wearable camera device of the present invention, a plurality of cameras are coupled to an elastic frame coupled to a neck and simultaneously generate images at various different view angles. Accordingly, there is an advantage of generating omnidirectional images including a rear side image that a user may not see.

In addition, the wearable camera device of the present invention has an advantage in that the user feels a comfortable wearing sensation even when wearing the wearable camera device for a long time because the elastic frame having elasticity is worn around the neck. In addition, since a plurality of electric lines are accommodated in the elastic frame, power can be supplied to a plurality of camera modules. Accordingly, the plurality of batteries can be replaced to increase a usage time of the camera module.

In addition, in the wearable camera device of the present invention, the elastic frame is fixed to the neck using a body fixing band to minimize movement of the camera module so that clearer image data can be obtained even when the user physically moves.

### DESCRIPTION OF DRAWINGS

FIG. 1 is a perspective view illustrating an entire configuration of a wearable camera device according to the present invention.

FIG. 2 is an exploded perspective view illustrating a disassembled configuration of the wearable camera device according to the present invention.

FIG. 3 is an exemplary view illustrating photographing angles of a plurality of cameras of the wearable camera device according to the present invention.

FIG. 4 is a schematic view illustrating an image transmission process of the wearable camera device according to the present invention.

FIGS. 5 and 6 are schematic views illustrating a state in which a user wears the wearable camera device according to the present invention.

### MODES OF THE INVENTION

Exemplary embodiments of the present invention will be described with reference to the accompanying drawings. The embodiments of the present invention may be made in various forms, and it is not to be interpreted that the scope of the present invention is limited by the embodiments which will be described in detail below. The embodiments of the invention are provided in order to fully explain the invention to those skilled in the art. Therefore, shapes and sizes of the elements in the drawings may be exaggerated for a clearer description. It should be noted that there is a case in which the same numerals are assigned to the same components. Detailed descriptions of known functions and configurations that may be determined to unnecessarily obscure the gist of the invention will be omitted.

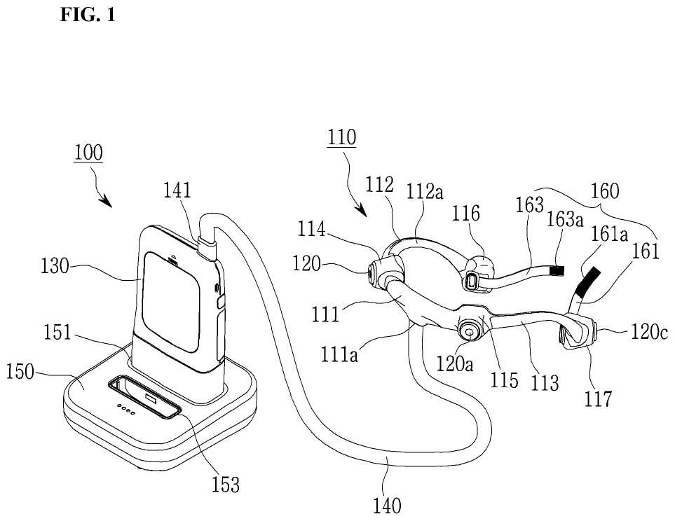

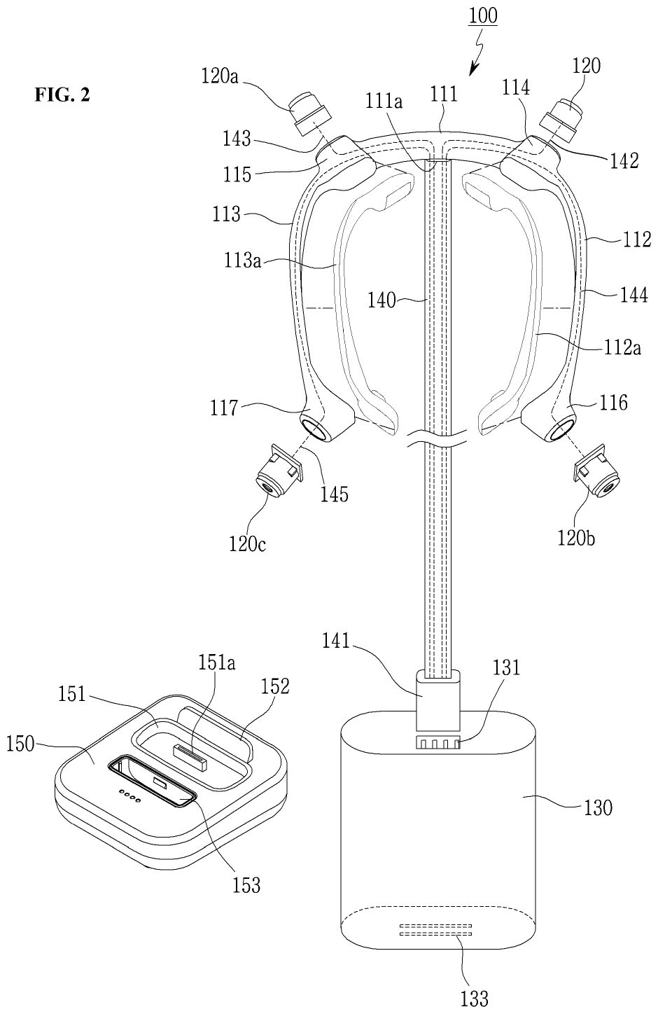

FIG. 1 is a perspective view illustrating a state in which a wearable camera device 100 according to the present invention is being charged, and FIG. 2 is an exploded perspective view illustrating a disassembled configuration of the wearable camera device 100.

As illustrated in the drawings, the wearable camera device 100 according to the present invention includes an elastic frame 110 detachably coupled to the neck of a user, a plurality of camera modules 120, 120a, 120b, and 120c coupled to the elastic frame 110, a battery 130 provided to be spaced apart from the elastic frame 110, a battery connection tube 140 connecting the elastic frame 110 and the battery 130 to allow power to be supplied to the plurality of camera modules 120, 120a, 120b, and 120c, a charging cradle 150 for charging the battery 130, and a body fixing band 160 which fixes the elastic frame 110 to the neck of the user.

The wearable camera device 100 according to the present invention has advantages in that the elastic frame 110 formed of an elastic material may be worn around the neck of the user to improve a wearing sensation and the plurality of camera modules 120, 120a, 120b, and 120c capture images at different heights and different angles to obtain the various images around the user.

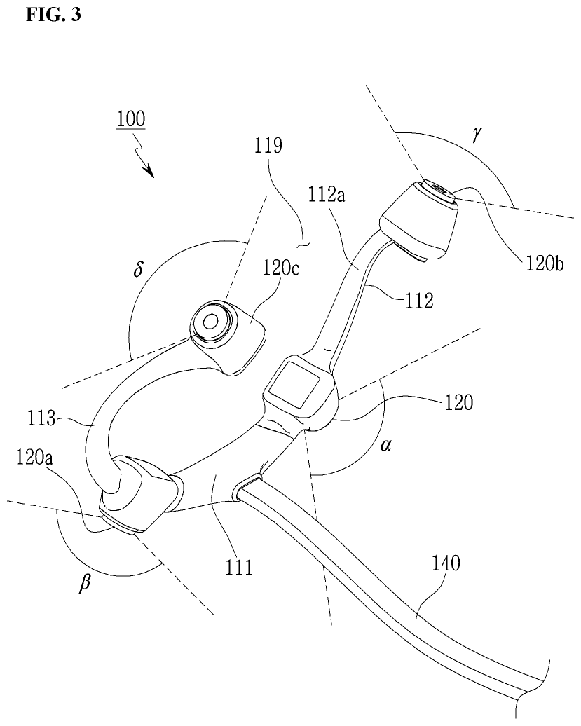

As illustrated in FIGS. 1 and 2, the elastic frame 110 is curved to have a “U” shape, is worn to surround the neck of the user, and supports the plurality of camera modules 120, 120a, 120b, and 120c. An opening 119 (see FIG. 3) may be formed in the front of the elastic frame 110, the opening 119 may elastically widen when the elastic frame 110 is worn around the neck, and the elastic frame 110 may be worn around the neck of the user. The opening 119 may be formed to correspond to a thickness of a neck of a general adult to allow the elastic frame 110 to be stably worn therearound. When the opening 119 is large, the elastic frame 110 may be separated or detached from the neck of the user.

The elastic frame 110 includes a back-neck frame 111 disposed behind the neck of the user, a left frame 112 and a right frame 113 which are formed to extend from both sides of the back-neck frame 111 toward a front of the neck of the user, a first camera holder 114 provided between the back-neck frame 111 and the left frame 112, a second camera holder 115 provided between the back-neck frame 111 and the right frame 113, a third camera holder 116 provided on an end portion of the left frame 112, and a fourth camera holder 117 provided on an end portion of the right frame 113.

The back-neck frame 111, the left frame 112, the right frame 113, and the plurality of camera holders 114, 115, 116, and 117 are integrally formed of an elastic material such as rubber or silicone through injection molding and the like.

In this case, a plurality of anti-slip protrusions having a hemisphere shape which prevents slipping when in contact with the skin of the user may be formed on an outer circumferential surface of the back-neck frame 111. Due to the anti-slip protrusions, an area in contact with the skin of the user is decreased and occurrence of sweat is reduced because air may be introduced between the anti-slip protrusions so that a more comfortable wearing sensation may be provided.

A left frame cover 112a and a right frame cover 113a are detachably coupled to the front of the left frame 112 and the front of the right frame 113 to install the camera modules 120, 120a, 120b, and 120c. The left frame cover 112a and the right frame cover 113a are also formed of an elastic material.

Since an entirety of the elastic frame 110 is formed of the elastic material as described above, when the wearable camera device is worn around the neck of the user, the user may not feel foreign body sensation but may feel a comfortable wearing sensation so that the user can wear the wearable camera device for a long time.

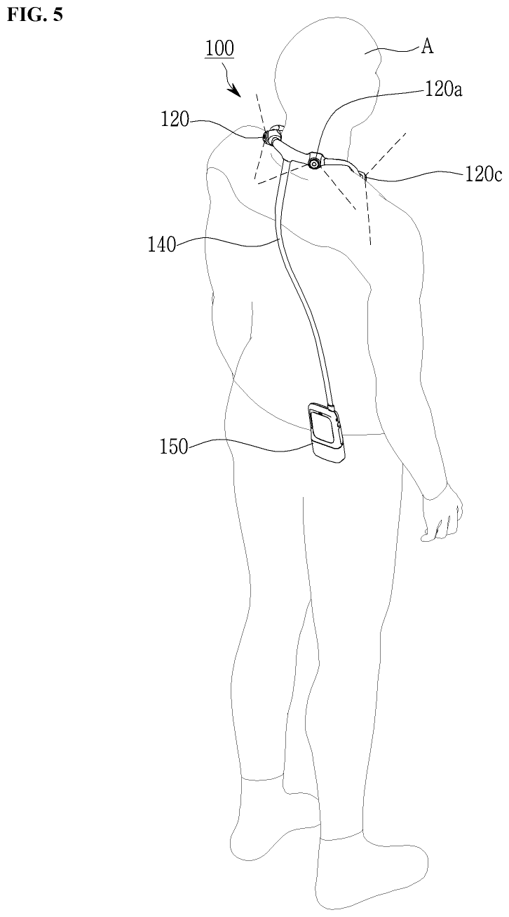

As illustrated in FIG. 5, the back-neck frame 111 is disposed behind a neck of a user A. The back-neck frame 111 is formed to have a T shape, the first camera holder 114 and the second camera holder 115 are provided at both sides of the back-neck frame 111, and a connection tube coupling hole 111ais provided in a lower portion of the back-neck frame 111. The back-neck frame 111 is formed in the form of a hollow tube having an empty interior.

As illustrated in FIG. 2, a plurality of camera power supply lines 142, 143, 144, and 145 are inserted into the back-neck frame 111 through the battery connection tube 140. Four camera power supply lines 142, 143, 144, and 145 are divided into two groups each having two camera power supply lines, moved to both sides of the back-neck frame 111, and guided to the plurality of camera modules 120, 120a, 120b, and 120c.

The left frame 112 and the right frame 113 are disposed to surround both sides of the neck and guide the third camera power supply line 144 and the fourth camera power supply line 145 to the third camera holder 116 and the fourth camera holder 117.

The left frame cover 112a and the right frame cover 113a are detachably coupled to the left frame 112 and the right frame 113. As illustrated in FIG. 2, in a state in which the left frame cover 112a and the right frame cover 113a are separated from the left frame 112 and the right frame 113, the camera modules 120, 120a, 120b, and 120c may be inserted into the corresponding camera holders 114, 115, 116, and 117, and the camera power supply lines 142, 143, 144, and 145 guided to respective positions thereof may be coupled to the corresponding camera modules 120, 120a, 120b, and 120c.

The first camera holder 114 accommodates the first camera module 120, the second camera holder 115 accommodates the second camera module 120a, the third camera holder 116 accommodates the third camera module 120b, and the fourth camera holder 117 accommodates the fourth camera module 120c.

As illustrated in FIG. 5, the first camera holder 114 and the second camera holder 115 support the first camera module 120 and the second camera module 120a such that the first camera module 120 and the second camera module 120a face in a backward direction of the user so as to generate an image of a rear side of the user.

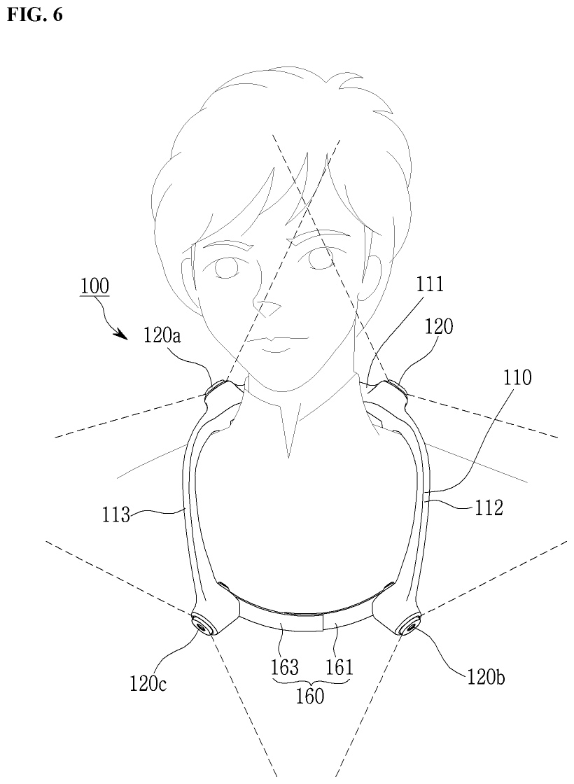

As illustrated in FIG. 6, the third camera holder 116 and the fourth camera holder 117 support the third camera module 120b and the fourth camera module 120c such that the third camera module 120b and the fourth camera module 120c face in a forward direction of the user so as to generate an image of a front side of the user.

The left frame 112 and the right frame 113 are formed to form a natural angle corresponding to an angle formed from the back-neck toward a front of the neck of the user. In some cases, the left frame 112 and the right frame 113 may be formed in the form of a corrugated tube so that shapes of the left frame 112 and the right frame 113 may be freely changed due to an external force applied by the user.

Accordingly, the elastic frame 110 may be used after the shape of the elastic frame 110 is changed to correspond to a body shape and a thickness of the neck of the user.

In this case, a sweat absorption cover (not shown) formed of a textile material such as cotton which absorbs sweat of the user may be additionally coupled to an outer portion of the elastic frame 110 of the present invention.

The plurality of camera modules 120, 120a, 120b, and 120c are respectively coupled to the camera holders 114, 115, 116, and 117 and generate images from the corresponding positions. The wearable camera device 100 according to the exemplary embodiment of the present invention includes four camera modules 120, 120a, 120b, and 120c.

The first camera module 120 is coupled to the first camera holder 114 to generate an image of a rear left side, the second camera module 120a is coupled to the second camera holder 115 to generate an image of a rear right side, the third camera module 120b is coupled to the third camera holder 116 to generate an image of a front left side, and the fourth camera module 120c is coupled to the fourth camera holder 117 to generate an image of a front right side.

The plurality of camera modules 120, 120a, 120b, and 120c are disposed at different positions and different heights according to a position at which the elastic frame 110 is coupled to the neck. The plurality of camera modules 120, 120a, 120b, and 120c face in forward directions from the corresponding positions and generate images. As illustrated in FIG. 3, the first camera module 120 generates an image within a range corresponding to a first view angle α, the second camera module 120a generates an image within a range corresponding to a second view angle β, the third camera module 120b generates an image within a range corresponding to a third view angle γ, and the fourth camera module 120c generates an image within a range corresponding to a fourth view angle δ.

In this case, it may be preferable that the camera modules 120, 120a, 120b, and 120c adjacent to each other be disposed on the elastic frame 110 such that view angles thereof have regions overlapping each other because images in 360° directions around the user may be obtained at once. To this end, arrangement positions of the first camera holder 114, the second camera holder 115, the third camera holder 116, and the fourth camera holder 117 are designed in consideration of the view angles of the plurality of camera modules 120, 120a, 120b, and 120c.

Meanwhile, each of the camera modules 120, 120a, 120b, and 120c may include an imaging device (not shown) configured to capture an image and an image processor (not shown) configured to process the image captured by the imaging device (not shown) into a digital image.

Since the wearable camera device 100 of the present invention is used in a state in which the wearable camera device 100 is coupled to the neck of the user, an image is captured while a position of the wearable camera device 100 is moved in conjunction with movement of the user. Accordingly, a shaken image may be captured. Therefore, the image processor (not shown) may correct original image data to generate clearer corrected image data.

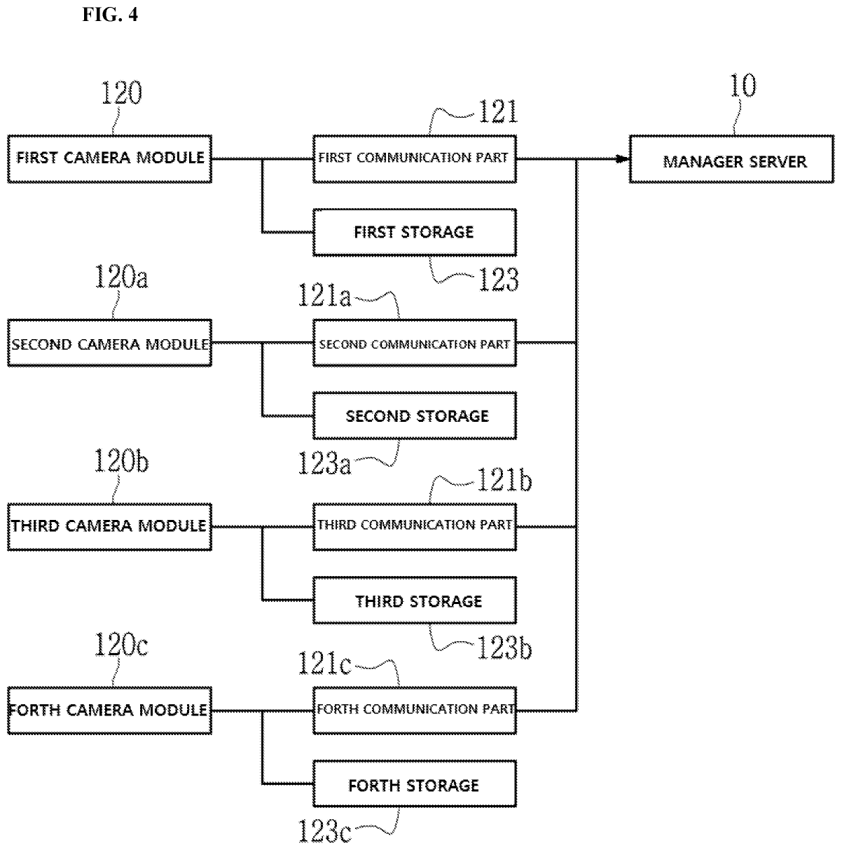

FIG. 4 is a schematic view illustrating a process of storing and transmitting images of the camera modules 120, 120a, 120b, and 120c of the present invention. As illustrated in the drawing, the camera modules 120, 120a, 120b, and 120c include wireless communication parts 121, 121a, 121b, and 121c configured to wirelessly communicate with a manager server 10. Image data generated by the camera modules 120, 120a, 120b, and 120c may be immediately transmitted to the manager server 10 by the wireless communication parts 121, 121a, 121b, and 121c and displayed on an image display of the manager server 10.

In some cases, image data may be transmitted to a manager terminal, for example, a smartphone, designated in the manager server 10.

In addition, the camera modules 120, 120a, 120b, and 120c may include separate storages 123, 123a, 123b, and 123c therein, respectively. The storages 123, 123a, 123b, and 123c in small memory types such as micro SD cards may be inserted into the camera modules 120, 120a, 120b, and 120c, and the user may separate the left frame cover 112a and the right frame cover 113a from the left frame 112 and the right frame 113 and separate the storages 123, 123a, 123b, and 123c from the camera modules 120, 120a, 120b, and 120c to check captured image data.

The battery 130 transmits power charged in the battery 130 to the plurality of camera modules 120, 120a, 120b, and 120c through the battery connection tube 140. As illustrated in FIG. 5, the battery 130 is fixed to the body of the user. The battery 130 can be inserted into a back pocket of pants, a waistband, a jumper pocket, or the like.

Although not illustrated in the drawings, the wearable camera device 100 may further include a fixing unit (not shown) which accommodates the battery 130 to fix the battery 130 to the clothes or body of the user. In a case in which the user is a police officer having many physical activities, the battery 130 may hinder movement of the user. Therefore, the battery 130 may be fixed to the body or clothes using the fixing unit (not shown). A fixing clip, fixing band, or fixing string may be used as the fixing unit (not shown).

As illustrated in FIG. 2, a connector socket 131 to be coupled to a connector 141 of the battery connection tube 140 is provided in an upper surface of the battery 130. A charging terminal 133 to be electrically connected to a plug 151a of the charging cradle 150 is provided in a lower surface of the battery 130.

As illustrated in FIG. 1, the battery 130 is charged through the charging cradle 150. The battery 130 is inserted into a battery charging groove 151 of the charging cradle 150, the charging terminal 133 comes into contact with the plug 151a, and the battery 130 receives power required for charging.

A remaining power display lamp (not shown) configured to display a remaining amount of charged power is provided on a surface of the battery 130 to allow the user to recognize a present remaining amount of charged power and predict a usable time of the camera modules 120, 120a, 120b, and 120c.

The battery 130 may be provided as a plurality of batteries to allow the user to replace the battery 130 with the auxiliary battery and use the wearable camera device 100 when the battery 130 is discharged.

The battery connection tube 140 allows power charged in the battery 130 to be supplied to the camera modules 120, 120a, 120b, and 120c. The battery connection tube 140 guides the plurality of camera power supply lines 142, 143, 144, and 145 accommodated therein to the elastic frame 110. The battery connection tube 140 may also serve to protect the camera power supply lines 142, 143, 144, and 145 therein such that the camera power supply lines 142, 143, 144, and 145 are not damaged due to physical activities of the user. To this end, the battery connection tube 140 may be formed to be coated with polyvinyl chloride (PVC) or rubber.

The connector 141 to be coupled to the connector socket 131 of the battery 130 is provided at a lower portion of the battery connection tube 140. Power is supplied to the plurality of camera power supply lines 142, 143, 144, and 145 through the connector 141.

An upper end of the battery connection tube 140 is coupled to a connection tube coupling hole 111a of the back-neck frame 111. A coupling region in which the connection tube coupling hole 111a is coupled to the battery connection tube 140 is sealed to prevent foreign materials or moisture from being introduced thereinto.

The charging cradle 150 charges the battery 130. As illustrated in FIG. 2, a plurality of battery charging grooves 151 and 153 are provided in an upper surface of the charging cradle 150. Accordingly, the plurality of batteries 130 can be simultaneously charged.

A battery support plate 152 may be provided at the battery charging grooves 151 and 153 to support the battery 130 such that the battery 130 is stably inserted into the battery charging grooves 151 and 153.

Meanwhile, the body fixing band 160 may be provided at the opening 119 of the elastic frame 110. As illustrated in FIG. 1, the body fixing band 160 includes a first band 161 and a second band 163 coupled to the right frame 113 and the left frame 112.

As illustrated in FIG. 6, the body fixing band 160 fixes the elastic frame 110 to the neck of the user when the user wears the wearable camera device 100 around his or her neck. Accordingly, the elastic frame 110 is prevented from moving and obtains clearer image data when the user physically moves.

Female and male pieces of Velcro 161a and 163a may be provided on the first band 161 and the second band 163 so that end portions of the first band 161 and the second band 163 may be coupled. In this case, the user may adjust a coupling position of the female and male pieces of Velcro 161a and 163a according to the thickness of the neck of the user.

An assembly process and a usage process of the wearable camera device 100 having such a configuration will be described with reference to FIGS. 1 to 6.

As illustrated in FIG. 2, in order to assemble the wearable camera device 100 of the present invention, the battery connection tube 140 accommodates the camera power supply lines 142, 143, 144, and 145 corresponding to the number of the camera modules 120, 120a, 120b, and 120c. End portions of the camera power supply lines 142, 143, 144, and 145 inserted into the battery connection tube 140 are introduced into the back-neck frame 111 through the connection tube coupling hole 111a, divided into two groups each having two end portions, and moved toward the left frame 112 and the right frame 113.

In a state in which the left frame cover 112a and the right frame cover 113a are opened, the camera modules 120, 120a, 120b, and 120c are connected to the corresponding camera power supply lines 142, 143, 144, and 145. In addition, the camera modules 120, 120a, 120b, and 120c are inserted into the corresponding camera holders 114, 115, 116, and 117.

When the camera modules 120, 120a, 120b, and 120c are completely coupled, the left frame cover 112a and the right frame cover 113a are insertion-coupled to the left frame 112 and the right frame 113.

In addition, an upper portion of the battery connection tube 140 is fixed to the connection tube coupling hole 111a and is sealed. The connector 141 is attached to a lower end of the battery connection tube 140.

As illustrated in FIG. 1, in order to use the wearable camera device 100, the battery 130 is inserted into the battery charging groove 151 of the charging cradle 150 and is charged. As illustrated in FIGS. 5 and 6, when the battery 130 is completely charged, the elastic frame 110 is coupled to the neck of the user.

The user widens the opening 119 to fit the elastic frame 110 onto the neck. The back-neck frame 111 is disposed behind the neck of the user, and the left frame 112 and the right frame 113 are positioned at both sides of the neck. The user inserts the battery 130 into a waist or pocket to fix a position of the battery 130.

In addition, the first band 161 and the second band 163 are coupled to fix a position of the elastic frame 110 to the neck of the user. Since the elastic frame 110 is formed of the elastic material, even when the elastic frame 110 is fixed to the neck, the user does not feel discomfort.

When power is applied to the plurality of camera modules 120, 120a, 120b, and 120c using a remote controller (not shown), power of the battery 130 is transmitted to the camera modules 120, 120a, 120b, and 120c, and the camera modules 120, 120a, 120b, and 120c generate image data corresponding to ranges of the corresponding view angles.

As illustrated in FIG. 4, pieces of image data of different directions generated by the camera modules 120, 120a, 120b, and 120c are transmitted to the manager server 10 through the wireless communication parts 121, 121a, 121b, and 121c.

Accordingly, situations around the user may be checked in 360° directions by the manager server 10 which is remote from the user. In the case of on-site suppression of a police officer, a manager positioned at the manager server may immediately check an on-site situation and check a nearby escape route of a criminal or a crime situation from various viewpoints.

As described above, in the wearable camera device of the present invention, since the plurality of cameras are coupled to the elastic frame coupled to the neck, images at different view angles are simultaneously generated. Accordingly, there is an advantage in that omnidirectional images including a rear side image that the user cannot see visually can be generated.

In addition, the wearable camera device of the present invention has an advantage in that the user can feel a comfortable wearing sensation even when wearing the wearable camera device for a long time because the elastic frame having elasticity is put on the neck. In addition, a plurality of electric lines are accommodated in the elastic frame to supply power to the plurality of camera modules. Accordingly, the plurality of batteries can be replaced to increase a usage time of the camera module.

In addition, in the wearable camera device of the present invention, the elastic frame is fixed to the neck using the body fixing band to minimize movement of the camera module so that clearer image data can be obtained even when the user physically moves.

The embodiments of the wearable camera device of the present invention are only examples, and it will be understood by those skilled in the art that various modifications and other equivalent example embodiments may be made. Therefore, it will be understood that the present invention is not limited to the forms mentioned through the detailed description. Therefore, the scope of the present invention is defined by the spirit of the appended claims. In addition, the present invention should be understood to cover all modifications, equivalents, and alternatives falling within the spirit and scope of the present invention defined by the appended claims.

1. A wearable camera device comprising:
an elastic frame (110) which is detachably coupled to a neck of a user and in which a plurality of camera holders (114, 115, 116, 117) are provided to be spaced apart from each other;
a plurality of camera modules (120, 120a, 120b, 120c) coupled to the plurality of camera holders (114, 115, 116, 117) to generate pieces of image data at different viewing angles around the user;
a battery (130) provided to be spaced apart from the elastic frame (110); and
a battery connection tube (140) which connects the battery (130) and the elastic frame (110) and guides a plurality of camera power supply lines (142, 143, 144, 145), through which power is supplied to the plurality of camera modules (120, 120a, 120b, 120c), to the elastic frame (110).

2. The wearable camera device of claim 1, wherein the elastic frame (110) includes:
a back-neck frame (111) which is disposed behind the neck of the user, has a lower portion in which a connection tube coupling hole (111a) coupled to the battery connection tube (140) is formed, accommodates the plurality of camera power supply lines (142, 143, 144, 145) therein, and is formed of an elastic material;
a left frame (112) and a right frame (113) which are formed to extend from both sides of the back-neck frame (111) toward a front of the neck of the user;
a first camera holder (114) which is provided between the back-neck frame (111) and the left frame (112) and accommodates a first camera module (120);
a second camera holder (115) which is provided between the back-neck frame (111) and the right frame (113) and accommodates a second camera module (120a);
a third camera holder (116) which is provided on an end portion of the left frame (112) and accommodates a third camera module (120b); and
a fourth camera holder (117) which is provided on an end portion of the right frame (113) and accommodates a fourth camera module (120c).

3. The wearable camera device of claim 2, further comprising a charging cradle (150) which is electrically connected to the battery (130) and charges the battery (130).

4. The wearable camera device of claim 3, wherein the plurality of camera modules (120, 120a, 120b, 120c) transmit the generated image data to a manager server through wireless communication.

5. The wearable camera device of claim 4, wherein the plurality of camera modules (120, 120a, 120b, 120c) include storages (123, 123a, 123b, 123c) which each store one of the pieces of generated image data.

6. The wearable camera device of claim 5, further comprising a body fixing band (160) provided on the end portion of each of the left frame (112) and the right frame (113) to fix the elastic frame (110) to the neck of the user.
